(19) United States
(12) Patent Application Publication
(10) Pub. No.: US 2020/0055139 A1
(43) Pub. Date: Feb. 20, 2020

(54) MANUFACTURING METHOD FOR WELDING A MULTI-SHEET ASSEMBLY

(71) Applicant: GM GLOBAL TECHNOLOGY OPERATIONS LLC, Detroit, MI (US)

(72) Inventors: Pei-chung Wang, Troy, MI (US); Michael J. Karagoulis, Okemos, MI (US); Zhenke Teng, Troy, MI (US); Spyros P, Mellas, Waterford, MI (US)

(21) Appl. No.: 16/103,203

(22) Filed: Aug. 14, 2018

(51) Int. Cl. B23K 11/11; B23K 11/30; B23K 11/16

(52) U.S. Cl. CPC B23K 11/115; B23K 11/16; B23K 11/3009

(57) ABSTRACT

A method of manufacturing a resistance weld in at least three overlying sheet metal layers includes the steps of: (1) providing a first sheet metal layer having a first thickness; (2) providing a second sheet metal layer having a second thickness; (3) providing a filler material on the second sheet metal layer; (4) providing a third sheet metal layer having a third thickness onto the filler material and the second sheet metal layer wherein the third thickness is less than each of the first and the second thicknesses; (5) pressing a pair of welding electrodes against a pair of opposing outer surfaces with the filler material disposed therebetween; and (6) passing an electric current between the pair of electrodes through the filler material and the first, second, and third sheet metal layers to form a weld nugget which penetrates into at least the first and second sheet metal layers.

### TECHNICAL FIELD

The present disclosure relates to a method to manufacture an electrical resistance weld between three or more sheet metal layers. More specifically, this disclosure relates to forming high quality weld nuggets between at least three sheet metal layers.

### BACKGROUND

Resistance welding processes are pressure welding processes in which heavy current is passed for a short time through the area of interface of metals to be joined. Filler material is traditionally not implemented as part of a resistance welding process. Heat is generated in localized area which is enough to heat the metal to a sufficient temperature, so that the parts can be joined with the application of pressure (or force). Pressure (Le., force/area) is applied through the electrodes.

The process may employ an example current of the order of 10,000 Amps, 1 V and 0.5 seconds. Force is normally applied before, during and after the flow of current to avoid arcing between the surfaces and to forge the weld metal during post heating. An example pressure may vary from 30 to 150 Nmm⁻² depending upon material to be welded and other welding conditions. For good quality welds, these parameters may be properly selected which shall depend mainly on material of components, their thicknesses, type and size of electrodes,

Current automotive vehicle manufacturing operations include, for example, the joining of two sheet metal layers by resistance welding. Vehicle body panels such as doors, hoods, deck lids and liftgates are often assembled by joining inner and outer panels stamped from sheet metal of suitable metal alloys. Ferrous or aluminum alloys are often used. The thickness of each sheet metal layer may vary from less than one millimeter to more than four millimeters.

Electrical resistance spot welding is often used to join such inner and outer panels or other metal parts. For example, an edge of an outer pan& sheet may be folded over an adjacent edge of an inner pan& sheet positioned in an assembly of the panels in which the hems are at the periphery of the sheets. The panel assembly is positioned for welding in areas removed from the hem joint. Axially aligned and opposing electrodes are pressed toward each other against opposite sides of the panel assembly. A momentary welding current is passed between the electrodes through the layers of metal to form a spot weld. The spot weld is characterized by a momentarily fused pool of metal and a re-solidified weld nugget at the interface of the contacting sheets. The electrodes are retracted and moved to another weld site.

In resistance spot welding, two sheets of metal are generally held between electrodes through which welding current is supplied for a definite time and also force is exerted on work pieces. The welding cycle starts with the upper electrode moving and contacting the work pieces resting on the lower electrode which is usually stationary. The work pieces are held under pressure and only then heavy current is passed between the electrodes for preset time. The area of metals in contact are rapidly raised to welding temperature, due to the flow of current through the contacting surfaces of work pieces. The pressure between electrodes, squeezes the hot metal together thus completing the weld. The weld nugget formed is allowed to cool under pressure and then pressure is released. This total cycle is known as resistance spot welding cycle. However, when three work pieces 112, 114, 116 must be welded together and at least one of the work pieces 112 has a reduced thickness relative to the others 114, 116, weld strength is compromised due to uneven heat distribution during the welding process which may result in an undersized weld 118 at the interface between a thin outer sheet 112 and the adjacent thicker metal sheet 114.

Referring now to FIG. 3A, a heat diagram is provided for a traditional spot-welded joint after passing current for 100 ms. As shown, heat 122 initiates (and significantly grows) at the interface 124 between the thick sheet metal layers 114, 116 (rather than at the interface 126 between the thin and thick sheet metal layers—elements 112 and 114 respectively) due to greater bulk resistivity between the thick sheet metal layers 114, 116 and less heat dissipation to the bottom electrode (i.e., joule heat dissipation is slowed down by the thick bottom work piece 116). Moreover, any heat at the interface 126 may also be reduced due to the close proximity of the water-cooled electrode 128 relative to interface 124. Referring now to FIG. 3B, the heat diagram for the traditional spot-welded joint is shown after passing current for 600 ms. Due to the asymmetrical heat distribution shown in FIG. 3B, the resulting weld nugget 118 is undersized as shown in FIG. 2 and may be approximately adjacent to the thin outer sheet metal layer 112. See FIG, 2. The failure of the weld nugget 118 to penetrate the thin outer sheet layer 112 weakens the joint at the interface 126 between the thin sheet metal layer 112 and the thick sheet metal layer 114.

Therefore, it is desirable to strengthen a resistance welded joint between three or more sheet metal layers which may have varying thicknesses.

### SUMMARY

The present disclosure provides a method of manufacturing an electrical resistance weld in an assembly of at least three overlying sheet metal layers. The method includes the steps of: (1) providing a first sheet metal layer having a first thickness; (2) providing a second sheet metal layer having a second thickness onto a first sheet metal layer; (3) providing a filler material on the second sheet metal layer; (4) providing a third sheet metal layer having a third thickness onto the filler material and the second sheet metal layer wherein the third thickness is less than each of the first and the second thicknesses; (5) pressing a pair of welding electrodes against a pair of opposing outer surfaces with the filler material disposed therebetween; and (6) passing an electric current between the pair of electrodes through the filler material and the first, second, and third sheet metal layers to form a weld nugget which penetrates into at least two sheet metal layers.

It is understood that the foregoing method may further comprise the steps of (7) bonding the third sheet metal layer to the second sheet metal layer via a brazed joint formed by the melted filler material; and (8) bonding the second sheet metal layer to the first sheet metal layer via a resistance spot weld formed by the weld nugget. Alternatively, the foregoing method may further comprise the steps of (7) heating the filler material together with the first, second, and third sheet metal layers so that at least a portion of the first, second, and third sheet metal layers melt together with the filler material at the weld site to form a cohesive weld nugget. Regardless of which of the foregoing methods are used, it is understood that the filler material is configured to melt at a lower temperature relative to the each of the first, second and third sheet metal layers.

In the above method, it is understood that a weld site is defined by the region of the first, second and third sheet metal layers between the pair of welding electrodes and the filler material is disposed on the second sheet metal layer at the weld site. The filler material may optionally, but not necessarily, be a copper alloy or an aluminum alloy, and the filler material may also optionally, but not necessarily have a porous structure. The filler material and the first, second and third sheet metal layers form a three-sheet assembly which is held between the pair of electrodes for a definite time period wherein the pair of electrodes exerts force on the three-sheet assembly and transfers a current through the three-sheet assembly. Under this scenario, the weld nugget becomes a spot weld upon cooling. Alternatively, under another non-limiting example scenario, each electrode in the pair of electrodes may be a roller which is configured to move relative to the three-sheet assembly at the weld site such that the weld nugget becomes part of a seam weld upon cooling.

It is also understood that the above method may further include an optional additional fourth step may of providing a fourth sheet metal layer and a second filler material which may optionally, but not necessarily, be disposed between the fourth sheet metal layer and an adjacent layer. The first, second and third sheet metal layers may also, but not necessarily each be formed from steel or aluminum alloy.

In yet another embodiment of the present disclosure, a method of forming an electrical resistance weld in an assembly of overlying sheet metal layers includes the steps of: (1) providing a plurality of sheet metal layers; (2) providing a filler material between at least two sheet metal layers in the plurality of sheet metal layers to form a multi-layer assembly; (3) pressing a pair of welding electrodes against a pair of opposing outer surfaces of the multi-layer assembly; and (4) passing an electric current between the pair of electrodes through the multi-layer assembly to form a weld nugget which penetrates each metal layer in the plurality of sheet metal layers.

It is understood that the foregoing method may further comprise the step of: (5) heating the filler material via the electric current so as to melt the filler material to create a brazed joint from the melted filler material. It is understood that under this arrangement a portion of the multi-layer assembly is bonded together via the brazed joint while another portion of the multi-layer assembly is bonded together via the weld nugget. Alternatively, the foregoing method may further comprise the step of: (5) heating the filler material via the electric current so as to melt the filler material together with at least a portion of each of the plurality of sheet metal layers disposed between the pair of welding electrodes so as form a cohesive weld nugget which penetrates each sheet metal layer in the plurality of sheet metal layers.

In the foregoing example method, a weld site may be defined by the region of the plurality of the sheet metal layers between the pair of welding electrodes and the filler material may be disposed at the weld site. Moreover, the filler material may optionally, but not necessarily, be either a copper alloy or an aluminum alloy. The foregoing example method may further include the step of cooling the weld nugget to form a spot weld. Alternatively, the foregoing example method may further include the step of moving the pair of welding electrodes relative to the multi-layer assembly to form an adjacent overlapping weld nugget which overlaps the weld nugget wherein the pair of welding electrodes are rollers. Under this latter alternative, the method may further include the step of cooling the adjacent overlapping weld nugget and the weld nugget to form a seam weld.

The present disclosure also provides for a resistance welded multi-sheet assembly which includes a plurality of sheet metal layers, a filler material and a weld configured to join the plurality of sheet metal layers. The plurality of sheet metal layers includes an interior sheet metal layer disposed between two exterior sheet metal layers. The filler material may be disposed between at least two sheet metal layers in the plurality of sheet metal layers. The weld extends through the interior metal layer and into each exterior metal layer by at least 10% of the thickness of exterior metal layer. Similarly, it is also understood that the filler material of the foregoing multi-sheet assembly may, but not necessarily, be either a copper alloy or an aluminum alloy.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a schematic front view of a resistance welded assembly having 3 sheet metal layers of varying thickness.

FIG. 2 is a cross-sectional view of a traditional resistance spot welded joint between three sheet metal layers.

FIG. 3A is a heat diagram for a traditional spot-welded joint after passing current for 100 ms using steel layers having thicknesses of 0.65 mm, 1.6 mm, and 1.5 mm respectively

FIG. 3B is a heat diagram for the traditional spot-welded joint in FIG. 3B at 600 ms.

FIG. 4A is a schematic diagram illustrating a non-limiting example manufacturing method of the present disclosure.

FIG. 4B is a schematic diagram illustrating a second non-limiting example manufacturing method of the present disclosure.

FIG. 5 is a cross-sectional view of an improved weld according to the present disclosure.

FIG. 6A is a heat diagram for an example spot-welded joint of the present disclosure after passing current for 100 ms using steel layers having thicknesses of 0.65 mm, 1.6 mm, and 1.5 mm respectively.

FIG. 6B is a heat diagram for an example spot-welded joint of the present disclosure after passing current for 600 ms using steel layers having thicknesses of 0.65 mm, 1.6 mm, and 1.5 mm respectively.

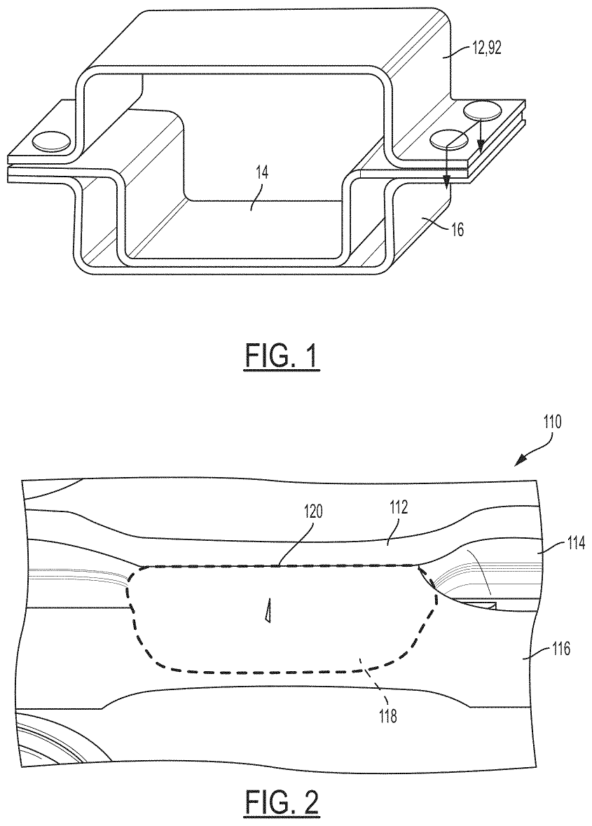

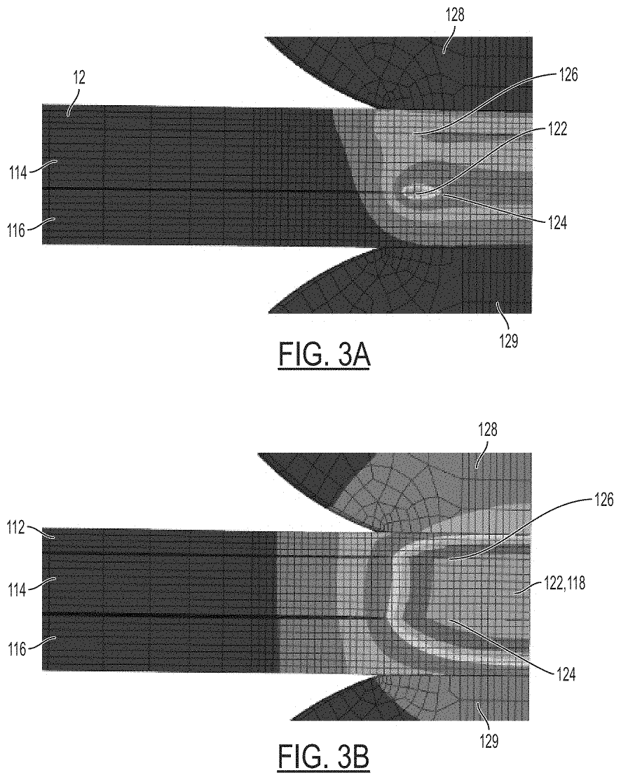

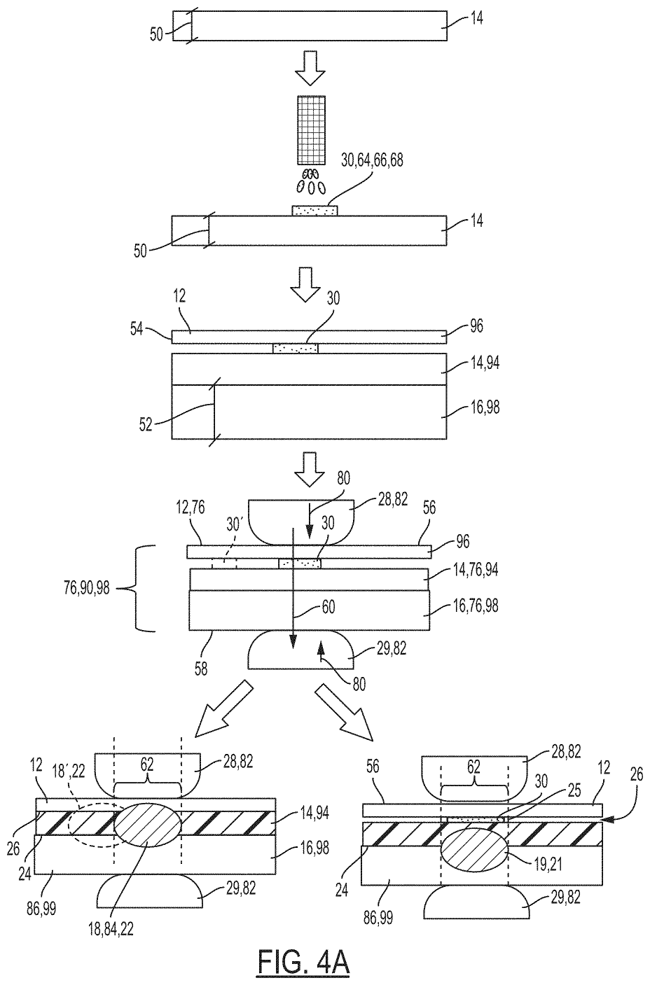

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred, Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the lifter body 14 of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

The terms “upper” and “lower” may be used with respect to regions of a single component and are intended to broadly indicate regions relative to each other wherein the “upper” region and “lower” region together form a single component. The terms should not be construed to solely refer to vertical distance/height.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

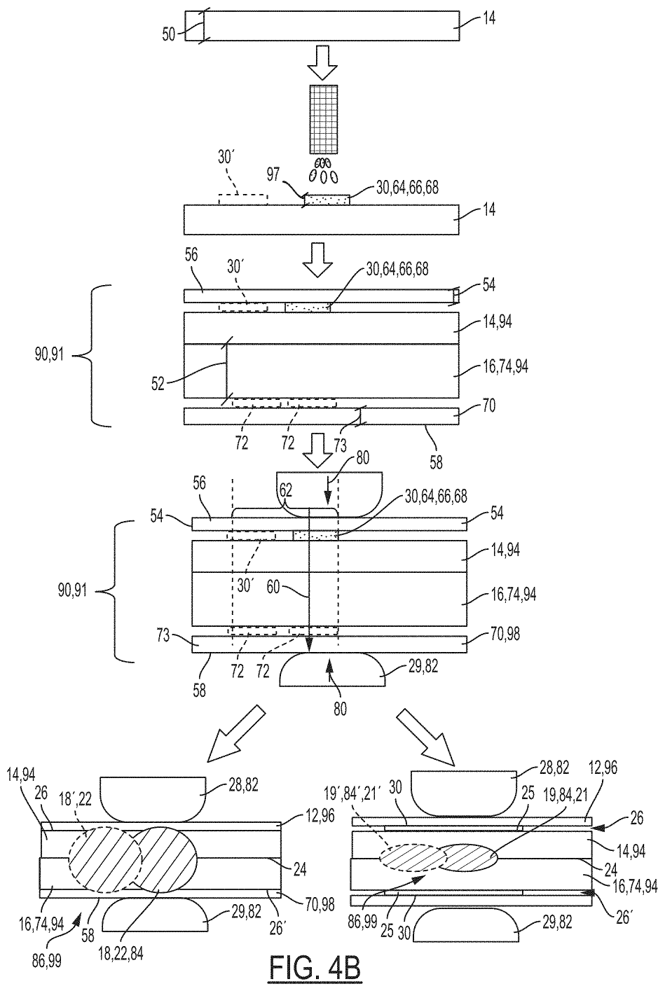

Referring now to FIG. 4A, the present disclosure provides a method of manufacturing an electrical resistance weld in an assembly of at least three overlying sheet metal layers. The method includes the steps of: (1) providing a first sheet metal layer 16 having a first thickness 52; (2) providing a second sheet metal layer 14 having a second thickness 50 onto a first sheet metal layer 16; (3) providing a filler material 30 on the second sheet metal layer 14; (4) providing a third sheet metal layer 12 having a third thickness 54 onto the filler material 30 and the second sheet metal layer 14 wherein the third thickness 54 is less than each of the first and the second thickness (elements 52 and 50 respectively); (5) pressing a pair of welding electrodes 28, 29 against a pair of opposing outer surfaces 56, 58 with the filler material 30 disposed therebetween; and (6) passing an electric current 60 between the pair of welding electrodes 28, 29 through the filler material 30 and the first, second, and third sheet metal layers (elements 16, 14, and 12 respectively) to form a weld nugget 18, 19 which penetrates into at least the first and second sheet metal layers. 14, 16. It is understood that, in all embodiments of the present disclosure, the filler material thickness 97 may, but not necessarily, fall in a range of about 0.1 mm to about 0.2 mm when the sheet metal layers have thicknesses which each fall in the range of about 0.25 mm to about 4.0 mm.

It is understood that the foregoing method may further comprise the steps of (7) bonding the third sheet metal layer 12 to the second sheet metal layer 14 via a brazed joint 25 formed by the melted filler material; and (8) bonding the second sheet metal layer 14 to the first sheet metal layer 16 via a resistance spot weld 21 formed by the weld nugget. Alternatively, the foregoing method may further comprise the steps of (7) heating the filler material together with the first, second, and third sheet metal layers so that at least a portion of the first, second, and third sheet metal layers melt together with the filler material at the weld site to form a cohesive weld nugget 18. Regardless of which of the foregoing methods are used, it is understood that the filler material is configured to melt at a lower temperature relative to the each of the first, second and third sheet metal layers.

It is understood that cohesive weld nugget 18 may, but not necessarily include at least a portion of the filler material 30 initially positioned at interface 26 (where filler material is provided) and extends beyond interface 24 such that the filler material 30 melts together with the first, second and third layers when current is applied. It is understood that traditional ratio of the first thickness 52 to the third thickness may, but not necessarily, generally not exceed a 1 to 2 ratio.

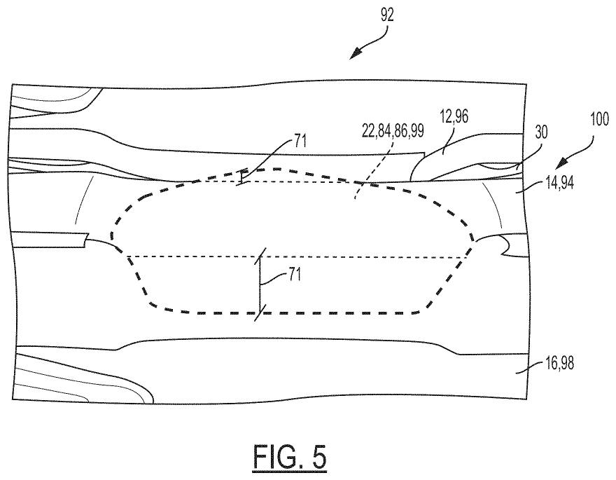

In the above method and as shown in FIG. 4A, it is understood that a weld site 62 is defined by the region of the first, second and third sheet metal layers (elements 16, 14, and 12 respectively) disposed between the pair of welding electrodes 28, 29. It is understood that the filler material 30 is positioned on the second sheet metal layer 14 at the region of weld site 62. The filler material 30 may optionally, but not necessarily, be a copper alloy 64 or an aluminum alloy 66, and the filler material 30 may also optionally, but not necessarily have a porous structure 68. As further shown in FIG. 4A, the filler material 30 and the first, second and third sheet metal layers 12, 14, 16 form a three-sheet assembly 78 which is held between the pair of welding electrodes 28, 29 for a definite time period such that the pair of welding electrodes 28, 29 exerts a force 80 on the three-sheet assembly 78 and transfers an electric current 60 through the three-sheet assembly 78. Under this scenario, the cohesive weld nugget 18 forms within the three-sheet assembly 78 and becomes a spot weld 84 upon cooling. As shown in FIG. 5, the spot weld 84 penetrates through the second sheet metal layer 14 and penetrates into the first and third sheet metal layers (elements 16 and 12 respectively). Alternatively, under another non-limiting example scenario, each electrode in the pair of welding electrodes 28, 29 may be a roller 82 which is configured to move relative to the three-sheet assembly 78 at the weld site 62 such that the weld 22 from the cohesive weld nugget 18 becomes a portion 99 of a seam weld 86 upon cooling. Each weld 22 in the seam weld 99 may be spaced apart from each other or may be overlapping relative to each other.

When manufacturing a seam weld 86 according to the present disclosure, three (or more) metal sheets 12, 14, 16, 70 (see FIG. 4B) may be gripped between two wheels or roller electrodes 28, 29, 82, and as described, an electric current 60 may passed through the metal sheets and electrodes to obtain either the continuous seam i.e. overlapping weld nuggets 18, 18′ (see FIGS. 4A and 4B) or intermittent seam i.e. weld nuggets 18 are equally spaced. Moreover, when seam welding, filler material 30, 30′ is provided at the weld site as shown in FIG. 4B. Welding current 60 may be continuous or in pulses. Overlapping of weld nuggets 18, 18′ may overlap relative to each other by about 10% to about 50%. When it is approaching around 50% then it is termed as a continuous weld.

Referring now to FIG. 4B, it is also understood that, prior to holding the multi-sheet assembly 90 between the pair of welding electrodes 28, 29, the above method may further include an optional additional fourth step of providing a fourth sheet metal layer 70 having a fourth thickness 73 and an optional second filler material 72 which may optionally, but not necessarily, be disposed between the fourth sheet metal layer 70 and an adjacent layer (element 16 in FIG. 4B), The fourth thickness 73 is less than the adjacent first thickness 52 as shown in FIG. 48. Accordingly, under this alternative, the cohesive weld nugget 18 penetrates each sheet metal layer and upon cooling, the spot weld 84 penetrates through all interior layer(s) (elements 14 and 16 in FIG. 4B) and into each exterior layer 12, 70 by a penetration distance 71 (see FIG. 5) of at least 10% of the thicknesses of the workpiece 12 and 70. In the methods shown in FIGS. 4A-4B, the metal layers 90 may, but not necessarily each be formed from steel (low carbon steel to advanced high strength steels), aluminum alloy-steel, or aluminum alloy.

In yet another embodiment of the present disclosure and as also demonstrated by both FIGS. 4A and 4B, a method of forming an electrical resistance weld in an assembly of overlying sheet metal layers includes the steps of: (1) providing a plurality of sheet metal layers 90; (2) providing a filler material 30 between at least two sheet metal layers (elements 12 and 14) in the plurality of sheet metal layers 90 to form a multi-layer assembly 91; (3) pressing a pair of welding electrodes 28, 29 against a pair of opposing outer surfaces 56, 58 of the multi-layer assembly 91; and (4) passing an electric current 60 between the pair of welding electrodes 28, 29 through the multi-layer assembly 91 to form a weld nugget 18, 19 which penetrates at least two sheet metal layers 12, 14, 16, 70 in the plurality of sheet metal layers 90. (see FIGS. 4A and 48). It is understood that the foregoing method may further comprise the step of: (5) heating the filler material 30 via the electric current 60 so as to melt the filler material 30 to create a brazed joint 25 from the melted filler material. It is understood that under this arrangement a portion of the multi-layer assembly is bonded together via the brazed joint 25 while another portion of the multi-layer assembly is bonded together via the weld nugget 19. (See FIGS. 4A and 4B). Alternatively, the foregoing method may further comprise the step of: (5) heating the filler material 30 via the electric current 60 so as to melt the filler material 30 together with at least a portion of each of the plurality of sheet metal layers 90 disposed between the pair of welding electrodes 28, 29 so as form a cohesive weld nugget 18 which penetrates each sheet metal layer 12, 14, 16, 70 in the plurality of sheet metal layers 90.

In the foregoing example method, a weld site 62 may be defined by the region of the plurality of the sheet metal layers 90 between the pair of welding electrodes 28, 29 and the filler material 30 may be disposed at the weld site 62. Moreover, the filler material 30 may optionally, but not necessarily, be either a copper alloy 64 or an aluminum alloy 66. The foregoing example method may further include the step of cooling the cohesive weld nugget 18 to form a spot weld 84 which penetrates each sheet metal layer. Alternatively, the foregoing example method may further include the step of moving the pair of welding electrodes 28, 29 relative to the multi-layer assembly 91 to form an adjacent (and optionally overlapping) cohesive weld nugget 18′ (shown in phantom in FIGS. 4A and 4B) which overlaps cohesive weld nugget 18 wherein the pair of welding electrodes 28, 29 are rollers 82. Under this latter alternative, the method may further include the step of cooling the adjacent (and optionally overlapping) cohesive weld nugget 18′ and the cohesive weld nugget 18 to form a seam weld 86.

With reference now to FIG. 5, the present disclosure also provides for a resistance welded multi-sheet assembly 98 which includes a plurality of sheet metal layers 90, a filler material 30 and a weld 84, 86 configured to join the plurality of sheet metal layers 90. The plurality of sheet metal layers 90 includes an interior sheet metal layer 94 disposed between two exterior sheet metal layers 96, 98. The filler material 30 may be disposed between at least two sheet metal layers 100 in the plurality of sheet metal layers 90. The weld 84, 86 extends through the interior sheet metal layer 94 and into each exterior metal layer 96, 98 by at least 10% of the thickness of exterior metal layers 96 and 98. Similarly, it is also understood that the filler material 30 of the foregoing multi-sheet assembly may, but not necessarily, be either a copper alloy 64 or an aluminum alloy 66.

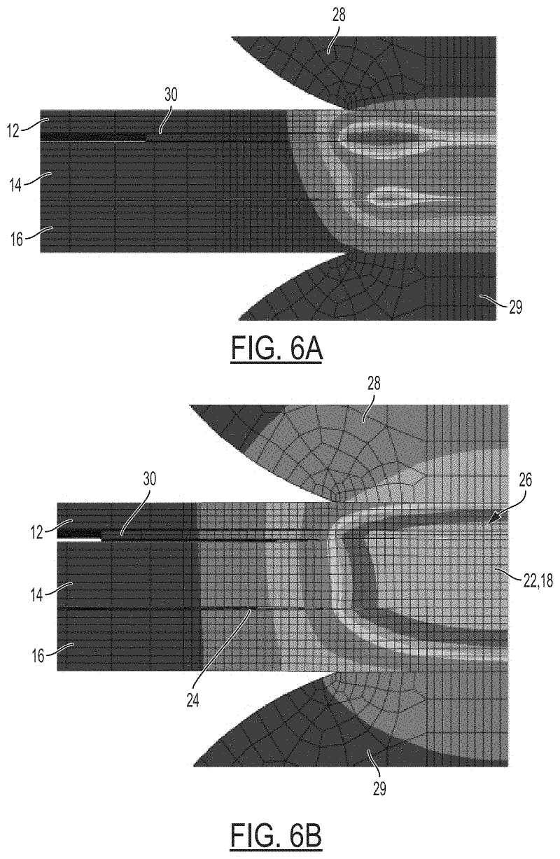

Referring now to FIGS. 6A, a heat diagram is provided which shows an example developing spot-welded joint of the present disclosure at 100 ms while FIG. 6B is a heat diagram for the same developing example spot-welded joint in FIG. 6A at 600 ms. The various foregoing methods of the present disclosure implement the use of filler material, such as but not limited to copper or aluminum alloys. Such filler material generally has a lower melting point than the sheet metal layers which may, but not necessarily, be made from steel. As a result, the foregoing methods and structure enable more robust (and even) bonding at interface 24 and interface 26 compared to traditional resistance welding processes. Accordingly, the cohesive weld nugget 18 (weld 22, 84, 86) penetrates through each interior sheet metal layer 94 and into each exterior sheet metal layer 96, 98.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of forming an electrical resistance weld in an assembly of overlying sheet metal layers, the method comprising the steps of:
providing a first sheet metal layer having a first thickness;
providing a second sheet metal layer having a second thickness onto a first sheet metal layer;
providing a filler material on the second sheet metal layer;
providing a third sheet metal layer having a third thickness onto the filler material and the second sheet metal layer wherein the third thickness is less than each of the first and the second thicknesses;
pressing a pair of welding electrodes against the opposing outer surfaces of the first sheet metal layer and the third sheet metal layer with the filler material disposed therebetween; and
passing an electric current between the pair of welding electrodes through the filler material and the first, second, and third sheet metal layers to melt the filler material and to form a weld nugget which penetrates into at least the first and second sheet metal layers.

2. The method as defined in claim 1 wherein a weld site is defined by the region of the first, second and third sheet metal layers between the pair of welding electrodes.

3. The method as defined in claim 2 wherein the filler material is disposed on the second sheet metal layer at the weld site.

4. The method as defined in claim 2 further comprising the steps of:
bonding the third sheet metal layer to the second sheet metal layer via a brazed joint formed by the melted filler material; and
bonding the second sheet metal layer to the first sheet metal layer via a resistance spot weld formed by the weld nugget.

5. The method as defined in claim 2 further comprising the step of:
heating the filler material together with the first, second, and third sheet metal layers so that at least a portion of the first, second, and third sheet metal layers melt together with the filler material at the weld site to form a cohesive weld nugget.

6. The method as defined in claim 3 further comprising the step of providing a fourth sheet metal layer and a second filler material disposed between the fourth sheet metal layer and an adjacent layer.

7. The method as defined in claim 4 wherein the filler material melts at a lower temperature relative to the each of the first, second and third sheet metal layers.

8. The method as defined in claim 5 wherein the filler material melts at a lower temperature relative to the each of the first, second and third sheet metal layers.

9. The method as defined in claim 4 wherein the first, second and third sheet metal layers are formed from steel.

10. The method as defined in claim 4 wherein each electrode in the pair of electrodes is a roller which is configured to move relative to the three-sheet assembly at the weld site.

11. The method as defined in claim 5 wherein each electrode in the pair of electrodes is a roller which is configured to move relative to the three-sheet assembly at the weld site.

12. The method as defined in claim 10 wherein the weld nugget is a seam weld upon cooling.

13. A method of forming an electrical resistance weld in an assembly of overlying sheet metal layers, the method comprising the steps of:
providing a plurality of sheet metal layers;
providing a filler material between at least two sheet metal layers in the plurality of sheet metal layers to form a multi-layer assembly;
pressing a pair of welding electrodes against a pair of opposing outer surfaces of the multi-layer assembly; and
passing an electric current between the pair of electrodes through the multi-layer assembly to form a weld nugget which penetrates at least two sheet metal layers in the plurality of sheet metal layers.

14. The method as defined in claim 13 further comprising the step of heating the filler material via the electric current so as to melt the filler material to create a brazed joint at the filler material.

15. The method as defined in claim 13 further comprising the step of heating the filler material via the electric current so to melt the filler material together with at least a portion of each of the plurality of sheet metal layers disposed between the pair of welding electrodes so as form a cohesive weld nugget which penetrates the plurality of sheet metal layers.

16. The method as defined in claim 15 wherein a weld site is defined by the region of the plurality of the sheet metal layers between the pair of welding electrodes.

17. The method as defined in claim 16 wherein the filler material is disposed at the weld site.

18. A resistance welded multi-sheet assembly comprising:
a plurality of sheet metal layers having an interior sheet metal layer disposed between two exterior sheet metal layers;
a filler material disposed between at least two sheet metal layers in the plurality of sheet metal layers; and
a weld which extends through the interior sheet metal layer and into at least one exterior sheet metal layer by at least 10% of the thickness of the at least one exterior metal layer.

19. The resistance welded multi-sheet assembly as defined in claim 18 wherein the filler material is one of a copper alloy or an aluminum alloy.
